(19) United States
(12) Patent Application Publication
(10) Pub. No.: US 2017/0169468 A1
(43) Pub. Date: Jun. 15, 2017

(54) METHOD AND SYSTEM FOR IDENTIFICATION OF CONTENT FOR ASSOCIATED INDIVIDUALS

(71) Applicant: MasterCard International Incorporated, Purchase, NY (US)

(72) Inventors: Randall K. SHUKEN, Westport, CT (US); Debashis GHOSH, Charlotte, NC (US); Manash BHATTACHARJEE, Jersey City, NJ (US); Harrison Reid SIEGEL, Glencoe, IL (US); Joseph Russell Shin LATTA, St. Louis, MO (US)

(73) Assignee: MasterCard International Incorporated, Purchase, NY (US)

(21) Appl. No.: 14/963,385

(22) Filed: Dec. 9, 2015

(51) Int. Cl. G06Q 30/02; G06Q 20/40

(52) U.S. Cl. CPC G06Q 30/0255; G06Q 20/4016

(57) ABSTRACT

A method for identifying content for an associated group of individuals includes: storing, transaction messages, each including a primary account number, merchant identifier, transaction time, and transaction data; identifying a plurality of transaction groups, each group including transaction messages with a common merchant identifier and where the transaction time is within a predetermined range of time; identifying an account group comprising a plurality of primary account numbers included in transaction messages in each of two or more of the transaction groups; identifying transaction behaviors based the transaction data in each transaction message included in the transaction groups that include a primary account number stored in the account group; identifying a content item based on the transaction behaviors; and electronically transmitting the content item via a communication network.

### FIELD

The present disclosure relates to the identification of content for a group of associated individuals, specifically the identification of purchase behaviors for a group of individuals identified based on common transactions and use thereof in the identification of content for distribution.

### BACKGROUND

Merchants, retailers, advertisers, and other types of content distributors often attempt to target specific consumers when distributing content. For example, an advertiser that wants to advertise a product may often try to identify consumers that are in an ideal market for the product being advertised. In many instances, a consumer may be evaluated based on their individual past behavior. For example, a merchant may consider that consumer's prior purchase in order to determine what products the consumer may purchase in the future, and use such information in the advertising of new products to the consumer. In another example, an individual's social network activity, such as the following of specific products, vendors, or manufacturers on a social network, may indicate the individual's preferences, which may be used in future targeting.

However, such methods are often only valuable as to individual consumers, and may therefore be unsuitable for content providers wanting to target an entire group of associated individuals. For example, a restaurant may be interested in targeting large groups of individuals for reservations and gatherings to achieve a higher conversion rate on advertisements than the targeting and advertisement to individual consumers. Using traditional systems, only individuals may be targeted with the restaurant relying on each individual in a group being targeted separately or relying on a targeted individual to convey an offer or other distributed content to the rest of the group.

Thus, there is a need for a technical solution for the identification of a group of associated individuals that may be used in the targeting of content for distribution. Furthermore, identifying data suitable for targeting based on the commonalities of the group of associated individuals may result in more effective targeting, particularly in the targeting of the group of associated individuals as a unified group.

### SUMMARY

The present disclosure provides a description of systems and methods for identifying content for an associated group of individuals.

A method for identifying content for an associated group of individuals includes: storing, in a transaction database of a processing server, a plurality of transaction messages, wherein each transaction message is formatted based on one or more standards and includes data related to a transaction including a plurality of data elements including at least a first data element configured to store a primary account number associated with a transaction account involved in the related transaction, a second data element configured to store a merchant identifier associated with a merchant involved in the transaction, a third data element configured to store a transaction time, and one or more additional data elements configured to store transaction data; identifying, by a transaction grouping module of the processing server, a plurality of transaction groups, wherein each transaction group includes a plurality of transaction messages where the merchant identifier stored in the second data element is a common merchant identifier and where the transaction time stored in the third data element is within a predetermined range of time; identifying, by an account grouping module of the processing server, an account group comprising a plurality of primary account numbers, wherein each primary account number is included in at least one of the plurality transaction messages in each of two or more of the identified plurality of transaction groups; identifying, by a transaction scoring module of the processing server, a plurality of transaction behaviors based on at least the transaction data stored in the one or more additional data elements included in each transaction message included in the two or more of the identified plurality of transaction groups where the primary account number stored in the first data element is included in the identified account group; identifying, by a content identification module of the processing server, at least one content item based on at least the identified plurality of transaction behaviors; and electronically transmitting, by a transmitting device of the processing server, a data signal superimposed with at least the identified at least one content item via a communication network.

A method for identifying fraudulent transactions based on individual relationships includes: storing, in a transaction database of a processing server, a plurality of transaction messages, wherein each transaction message is formatted based on one or more standards and includes data related to a transaction including a plurality of data elements including at least a first data element configured to store a primary account number associated with a transaction account involved in the related transaction, a second data element configured to store a merchant identifier associated with a merchant involved in the transaction, a third data element configured to store a transaction time, and one or more additional data elements configured to store transaction data; identifying, by a transaction grouping module of the processing server, a plurality of transaction groups, wherein each transaction group includes a plurality of transaction messages where the merchant identifier stored in the second data element is a common merchant identifier and where the transaction time stored in the third data element is within a predetermined range of time; identifying, by an account grouping module of the processing server, an account group comprising a plurality of primary account numbers, wherein each primary account number is included in at least one of the plurality transaction messages in each of two or more of the identified plurality of transaction groups; calculating, by a transaction scoring module of the processing server, a fraud score for the identified account group based on at least a correlation between at least one of: the common merchant identifier stored in the second data element, the transaction time stored in the third data element, and transaction data stored in the one or more additional data elements included in a transaction message in each of the identified plurality of transaction groups where the primary account number stored in the first data element is included in the identified account group; and electronically transmitting, by a transmitting device of the processing server, a data signal superimposed with at least the calculated fraud score and a respective primary account number, for each primary account number of the plurality of primary account numbers comprising the identified account group, to a financial institution associated with the respective primary account number.

A system for identifying content for an associated group of individuals includes: a transaction database of a processing server configured to store a plurality of transaction messages, wherein each transaction message is formatted based on one or more standards and includes data related to a transaction including a plurality of data elements including at least a first data element configured to store a primary account number associated with a transaction account involved in the related transaction, a second data element configured to store a merchant identifier associated with a merchant involved in the transaction, a third data element configured to store a transaction time, and one or more additional data elements configured to store transaction data; a transaction grouping module of the processing server configured to identify a plurality of transaction groups, wherein each transaction group includes a plurality of transaction messages where the merchant identifier stored in the second data element is a common merchant identifier and where the transaction time stored in the third data element is within a predetermined range of time; an account grouping module of the processing server configured to identify an account group comprising a plurality of primary account numbers, wherein each primary account number is included in at least one of the plurality transaction messages in each of two or more of the identified plurality of transaction groups; a transaction scoring module of the processing server configured to identify a plurality of transaction behaviors based on at least the transaction data stored in the one or more additional data elements included in each transaction message included in the two or more of the identified plurality of transaction groups where the primary account number stored in the first data element is included in the identified account group; a content identification module of the processing server configured to identify at least one content item based on at least the identified plurality of transaction behaviors; and a transmitting device of the processing server configured to electronically transmit a data signal superimposed with at least the identified at least one content item via a communication network.

A system for identifying fraudulent transactions based on individual relationships includes: a transaction database of a processing server configured to store a plurality of transaction messages, wherein each transaction message is formatted based on one or more standards and includes data related to a transaction including a plurality of data elements including at least a first data element configured to store a primary account number associated with a transaction account involved in the related transaction, a second data element configured to store a merchant identifier associated with a merchant involved in the transaction, a third data element configured to store a transaction time, and one or more additional data elements configured to store transaction data; a transaction grouping module of the processing server configured to identify a plurality of transaction groups, wherein each transaction group includes a plurality of transaction messages where the merchant identifier stored in the second data element is a common merchant identifier and where the transaction time stored in the third data element is within a predetermined range of time; an account grouping module of the processing server configured to identify an account group comprising a plurality of primary account numbers, wherein each primary account number is included in at least one of the plurality transaction messages in each of two or more of the identified plurality of transaction groups; a transaction scoring module of the processing server configured to calculate a fraud score for the identified account group based on at least a correlation between at least one of: the common merchant identifier stored in the second data element, the transaction time stored in the third data element, and transaction data stored in the one or more additional data elements included in a transaction message in each of the identified plurality of transaction groups where the primary account number stored in the first data element is included in the identified account group; and a transmitting device of the processing server configured to electronically transmit a data signal superimposed with at least the calculated fraud score and a respective primary account number, for each primary account number of the plurality of primary account numbers comprising the identified account group, to a financial institution associated with the respective primary account number.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a block diagram illustrating a high level system architecture for the identification of content for distribution and identification of fraud associated with an associated group of individuals identified via transaction data in accordance with exemplary embodiments.

FIG. 2 is a block diagram illustrating the processing server of FIG. 1 for the identification of an associated group of individuals via transaction data and distribution of content thereto or identification of fraud involving thereof in accordance with exemplary embodiments.

FIG. 3 is a flow diagram illustrating a process for the identification and distribution of content to an associated group of individuals using the system of FIG. 1 in accordance with exemplary embodiments.

FIG. 4 is a diagram illustrating the identification of an associated group of individuals based on transaction data in accordance with exemplary embodiments.

FIG. 5 is a flow diagram illustrating a process for the identification of fraud affecting an associated group of individuals using the system of FIG. 1 in accordance with exemplary embodiments.

FIG. 6 is a flow chart illustrating an exemplary method for identifying content for an associated group of individuals in accordance with exemplary embodiments.

FIG. 7 is a flow chart illustrating an exemplary method for identifying fraudulent transactions based on individual relationships in accordance with exemplary embodiments.

FIG. 8 is a flow diagram illustrating the processing of a payment transaction in accordance with exemplary embodiments.

FIG. 9 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Glossary of Terms

Payment Network—A system or network used for the transfer of money via the use of cash-substitutes. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, transaction accounts, etc. Examples of networks or systems configured to perform as payment networks include those operated by MasterCard®, VISA®, Discover®, American Express®, PayPal®, etc. Use of the term “payment network” herein may refer to both the payment network as an entity, and the physical payment network, such as the equipment, hardware, and software comprising the payment network.

Transaction Account—A financial account that may be used to fund a transaction, such as a checking account, savings account, credit account, virtual payment account, etc. A transaction account may be associated with a consumer, which may be any suitable type of entity associated with a payment account, which may include a person, family, company, corporation, governmental entity, etc. In some instances, a transaction account may be virtual, such as those accounts operated by PayPal®, etc.

Merchant—An entity that provides products (e.g., goods and/or services) for purchase by another entity, such as a consumer or another merchant. A merchant may be a consumer, a retailer, a wholesaler, a manufacturer, or any other type of entity that may provide products for purchase as will be apparent to persons having skill in the relevant art. In some instances, a merchant may have special knowledge in the goods and/or services provided for purchase. In other instances, a merchant may not have or require any special knowledge in offered products. In some embodiments, an entity involved in a single transaction may be considered a merchant. In some instances, as used herein, the term “merchant” may refer to an apparatus or device of a merchant entity.

Payment Transaction—A transaction between two entities in which money or other financial benefit is exchanged from one entity to the other. The payment transaction may be a transfer of funds, for the purchase of goods or services, for the repayment of debt, or for any other exchange of financial benefit as will be apparent to persons having skill in the relevant art. In some instances, payment transaction may refer to transactions funded via a payment card and/or payment account, such as credit card transactions. Such payment transactions may be processed via an issuer, payment network, and acquirer. The process for processing such a payment transaction may include at least one of authorization, batching, clearing, settlement, and funding. Authorization may include the furnishing of payment details by the consumer to a merchant, the submitting of transaction details (e.g., including the payment details) from the merchant to their acquirer, and the verification of payment details with the issuer of the consumer's payment account used to fund the transaction. Batching may refer to the storing of an authorized transaction in a batch with other authorized transactions for distribution to an acquirer. Clearing may include the sending of batched transactions from the acquirer to a payment network for processing. Settlement may include the debiting of the issuer by the payment network for transactions involving beneficiaries of the issuer. In some instances, the issuer may pay the acquirer via the payment network. In other instances, the issuer may pay the acquirer directly. Funding may include payment to the merchant from the acquirer for the payment transactions that have been cleared and settled. It will be apparent to persons having skill in the relevant art that the order and/or categorization of the steps discussed above performed as part of payment transaction processing.

### System for Distribution of Content to an Associated Group of Individuals

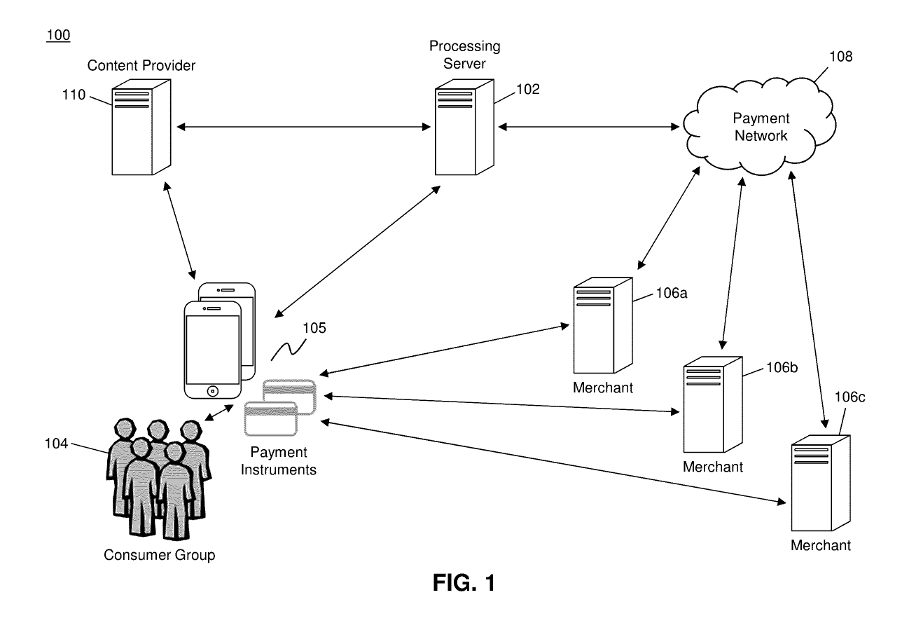

FIG. 1 illustrates a system 100 for the identification of an associated group of individuals using electronic transaction data and the identification of content for the distribution thereto based on transaction behaviors and the identification of fraud involving the associated group of individuals based on the association.

The system 100 may include a processing server 102. The processing server 102, discussed in more detail below, may be a specifically configured computing system configured to identify an associated group of individuals based on transaction data and identify purchase behaviors based thereon for the distribution of content. In the system 100, a consumer group 104 comprising a plurality of individuals may conduct payment transactions involving a plurality of different merchants 106, illustrated in FIG. 1 as merchants 106a, 106b, and 106c. Each of the individuals in the consumer group 104 may conduct a payment transaction with each of the merchants 106 using a payment instrument 105. Payment instruments 105 may include payment cards, mobile computing devices (e.g., smart phones, cellular phones, tablet computers, wearable computing devices, implantable computing devices, etc.), and other suitable payment instruments configured to convey payment credentials to the merchant 106 for use in conducting the payment transaction. Methods for conveying payment credentials to a merchant 106 using a payment instrument 105 will be apparent to persons having skill in the relevant art, which may include reading a magnetic stripe, near field communication, reading machine-readable codes, etc.

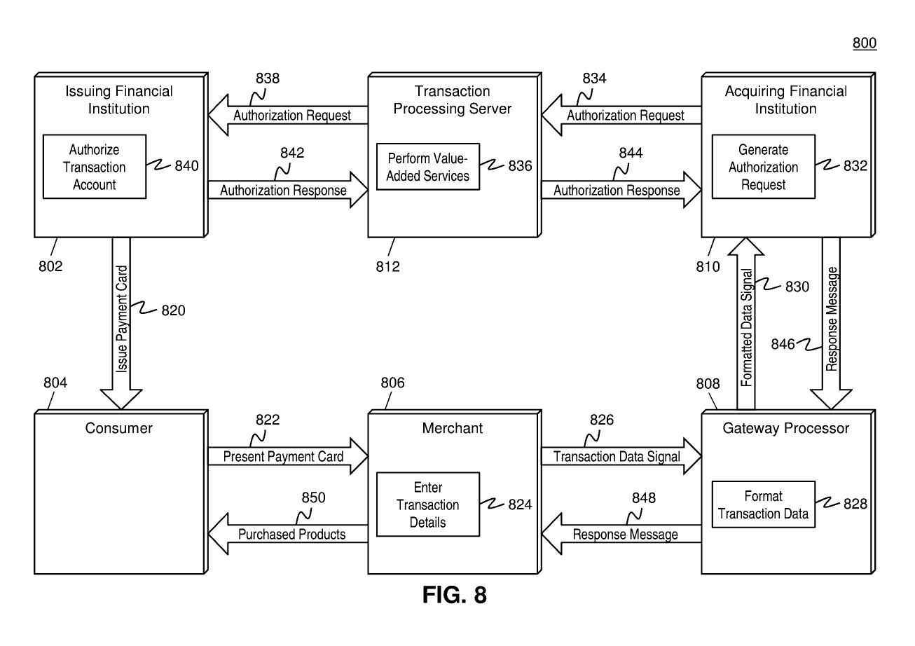

Each time an individual in the consumer group 104 presents payment credentials for payment, the credentials may be captured by the merchant 106 and included in transaction data that is transmitted to a payment network 108 for processing. Transaction data may be electronically transmitted to the payment network 108 via the payment rails, and may be transmitted directly by the merchant 106 or via one or more intermediate entities, such as a gateway processor, acquiring financial institution, etc. In some embodiments, the transaction data may be included in a transaction message that is electronically transmitted to the payment network 108 via the payment rails. A transaction message may be an electronic data message that is formatted based on one or more standards governing the exchange of financial transaction messages, such as the International Organization of Standardization's ISO 8583 standard. Each transaction message may include a plurality of data elements as set forth in the associated standard(s), where each data element may be configured to store data associated with the related payment transaction, as well as a message type indicator indicative of a type of the payment transaction, a bitmap configured to indicate what data elements and data included therein are included in the transaction message, and other suitable data. Additional information regarding transaction messages and the payment rails is discussed in more detail below with respect to the process 800 illustrated in FIG. 8.

The payment network 108 may receive the transaction message for a payment transaction involving a merchant 106 and one of the individuals in the consumer group 104 and process the payment transaction using traditional methods and systems. The payment network 108 may continue to process payment transactions such that each individual in the consumer group 104 has been involved in a payment transaction with each of the merchants 106. For example, a merchant 106 may be a restaurant at which the consumer group 104 goes for happy hour, with each of the individuals in the consumer group conducting a payment transaction to pay for food and drinks. In another example, the merchant 106 may be a sporting venue, with each of the individuals in the consumer group conducting a payment transaction involving the venue to purchase admission, concessions, or souvenirs.

The processing server 102 may be configured to identify the individuals in the consumer group 104 based on the transaction data for the payment transactions involving the individuals in the consumer group 104 and the merchants 106. In some embodiments, the payment network 108 may electronically transmit the transaction messages used in the processing of the payment transactions to the processing server 102 for use in the processes discussed herein. In some instances, the transaction messages may be electronically transmitted to the processing server 102 via the payment rails. In other instances, an alternative, suitable communication network may be used, such as a local area network, a wireless area network, or other network specifically configured to transmit transaction messages. In some embodiments, the processing server 102 may be a part of the computing system of the payment network 108. In such embodiments, the processing server 102 may receive the transaction messages via internal communication processes of the payment network 108. In some cases, the processing server 102 may be configured to perform processing for the related payment transactions and may receive transaction messages thereby.

The transaction messages may include data elements configured to store a primary account number associated with a transaction account used to fund the related payment transaction, a merchant identifier associated with a merchant 106 involved in the related payment transaction, a transaction time, and additional transaction data. Additional transaction data may include, for example, a transaction amount, point of sale data, consumer data, merchant data, offer data, loyalty data, reward data, issuer data, acquirer data, etc. The processing server 102 may be configured to identify the consumer group 104 using the received transaction messages.

The processing server 102 may identify groups of transaction messages where each transaction message in a group includes a common merchant identifier stored in the corresponding data element and includes a transaction time in the corresponding data element that is within a predetermined period of time. Such a transaction group may therefore correspond to a group of transactions at a single merchant 106 processed within a predetermined period of time, which may indicate individuals that are at the merchant 106 together. The predetermined period of time may be based on a variety of suitable criteria, such as the transaction amount (e.g., more time for larger purchases that may take longer than smaller purchases), the merchant 106 (e.g., more time at a sporting venue or a salon and less time at a bar), the time of day (e.g., more time during a busy lunch hour than in the middle of the afternoon), etc.

Once the groups of transactions are identified, the processing server 102 may identify the consumer group 104 by identifying a set of common primary account numbers that are included in one or more transaction messages in two or more of the transaction groups. In other words, the processing server 102 may identify a set of transaction accounts that are used in transactions at a single merchant 106 at the same time (e.g., within the predetermined period of time) multiple times (e.g., subsequent visits at the same merchant 106 or at a different merchant 106). This may therefore indicate a consumer group 104 of individuals that visit merchants 106 together and conduct payment transactions.

In some embodiments, the consumer group 104 identified by the processing server 102 may include only those consumers associated with transaction accounts that are involved in payment transactions in each of a plurality of transaction groups. In other embodiments, a consumer group 104 may include transaction accounts that are involved in payment transactions in a majority of transaction groups. For example, a consumer group 106 may consist of a group of six individuals, where four or five individuals are involved in a group of transactions at any given time, with one or two individuals not participating in every group outing.

Once the consumer group 104 is identified, the processing server 102 may identify purchase behaviors associated with the consumer group 104. Purchase behaviors may correspond to behavior of the consumer group 104 as associated with payment transactions, based on the transaction data included in the transaction messages related to the payment transactions involving the consumer group 104 and their visits to merchants 106. Purchase behaviors, also referred to herein as transaction behaviors, may include one or more metrics associated with spending of the consumer group 104 which may include, for example, number of transactions, transaction frequency, average ticket size, aggregate transaction amount, etc., and may be identified for one or more merchants, merchant categories, geographic locations, periods of time, etc., or combinations thereof. For instance, purchase behaviors may include a propensity to visit a specific merchant at a specific time, propensity to visit a type of merchant in a geographic area, likelihood of spending amount, frequency of spending, etc.

In exemplary embodiments, the purchase behaviors may be identified based on the transaction data stored in the additional data elements included in each of the transaction messages in the groups of transactions that include a primary account number associated with an individual in the consumer group 104, and may not be based on transaction data for transaction messages outside of transactions conducted as part of the consumer group 104. In such instances, the purchase behaviors may therefore be associated with the consumer group 104 as a whole, and not an individual consumer in the consumer group 104. As a result, the purchase behaviors may be associated with outings and spending of the consumer group 104, without regard to an individual's purchase behavior, and may therefore be more effective in the targeting of spending for the consumer group 104 as a unified group.

The system 100 may also include a content provider 110. The content provider 110 may be configured to distribute content to individuals in the consumer group 104 using traditional methods and systems. In some embodiments, the content provider 110 may provide content to the processing server 102. In such embodiments, the processing server 102 may identify content and distribute the identified content to the individuals in the consumer group 104 using known methods and systems for the distribution of content, such as the electronic transmission of data signals superimposed with content to computing devices and systems associated with the individuals. For example, an individual in the consumer group 104 may register a computing device with the processing server 102 for the receipt of offers, and the processing server 102 may electronically transmit offers identified for the consumer group 104 to the registered computing device.

Content may be identified based on the purchase behaviors identified for the consumer group 104. In embodiments where the content provider 110 may identify the content, the processing server 102 may electronically transmit the identified purchase behaviors to the content provider 110 using a suitable communication network, such as a cellular communication network, the Internet, a local area network, a radio frequency network, etc. In other embodiments, the processing server 102 may identify content provided by the content provider 110 and stored in computing systems associated with the processing server 102 (e.g., in a local database or an external database accessible by the processing server 102, such as via cloud computing techniques). The content may be based on the purchase behaviors such that the content may be associated with the purchase behaviors of the consumer group 104. For example, if the purchase behaviors indicate a high propensity to visit restaurants during happy hour, the content may be an advertisement of a local restaurant's happy hour. In another example, if the purchase behaviors indicate a high propensity to play golf, the content may be an offer for reduced green fees at a golf course.

In some embodiments, the content may include offers for discounts or other rewards associated with the purchase of one or more goods or services. In some instances, a value of the offer may be based on the number of individuals in the consumer group 104. In other instances, the value of the offer may be based on a number of individuals in the consumer group 104 that indicates acceptance of the offer upon distribution to the respective individual. For example, an offer for reduced green fees at a golf course distributed to the consumer group 104 may have a higher reduction in fees for the more individuals in the consumer group 104 that indicate a desire to use, or that actually use, the offer.

In some instances, the processing server 102 may be configured to perform additional functions associated with the distribution of the content to the consumer group 104. Additional functions may include, for instance, the tracking of acceptances and/or usage of content, the determination and distribution of metrics for consumer groups 104 and content, etc. For example, the processing server 102 may be configured to track acceptance of offers distributed to individuals in a consumer group 104 and usage of distributed offers, and may provide data associated therewith to the content provider 110 and/or associated merchants 106. In another example, the processing server 102 may notify a merchant 106 when an offer associated therewith is distributed to a consumer group 104, and may provide information associated with that consumer group 104, such as their size, purchase behaviors, etc. In yet another example, the processing server 102 may distribute purchase behaviors or other metrics, such as size, frequency, etc., associated with consumer groups 104 to merchants 106 or other entities associated therewith. For instance, the processing server 102 may determine an average size of consumer groups 104 that have transacted at a particular merchant 106 and provide such data to the merchant 106, which may be used in advertising, development of offers, arrangement of furnishings, etc.

In some embodiments, the processing server 102 may also be configured to identify fraudulent transactions involving the consumer group 104 based on the identified relationship. For instance, the processing server 102 may identify groups of transactions and a consumer group 104 of individuals based thereon, as discussed above. The processing server 102 may calculate a fraud score based on transaction data identified in the groups of transactions to determine a likelihood of fraud. The fraud score may be calculated via the application of one or more algorithms to transaction data stored in the transaction messages. For example, the fraud score may be calculated based on a correlation between merchant identifiers, between transaction times, between transaction dates, and between other transaction data (e.g., merchant industry, transaction amount, product data) included in transaction messages in each of the transaction groups involving the consumer group 104.

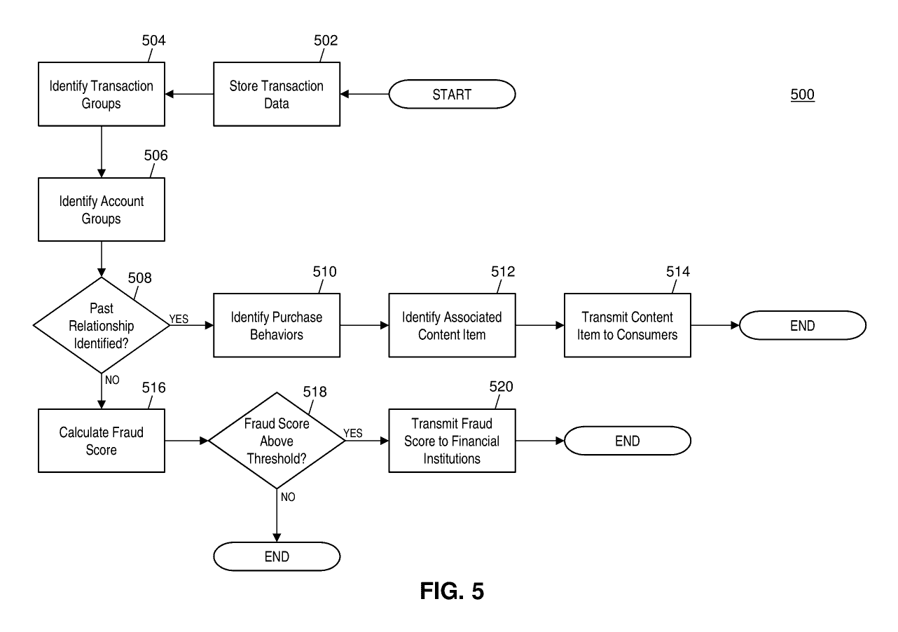

In one example, payment cards associated with a plurality of individuals may be stolen by a nefarious person. The person may use each of the stolen payment cards to purchase gas or other fuel at a series of gas stations in quick succession. The processing server 102 may identify the purchases as transaction groups and may identify a consumer group 104 of each of the individuals due to the repeated usage of their stolen payment cards at the same merchant and at the same time. However, additional data associated with the purchases may be used to identify if the transactions are fraudulent. For instance, the fraud may be indicated based on a lack of prior relationship between the individuals in the consumer group 104 (e.g., based on transaction dates in the transaction groups), the transaction behavior being uncharacteristic for the individuals in the consumer group 104 (e.g., based on prior transaction data), commonality in the merchant industry of the merchants (e.g., gas stations), value of the transactions, speed at which the transaction are conducted, geographic location of the transactions, commonality or difference in demographics of the consumer group 104, etc. Further details of this process are explained with reference to FIG. 5, as discussed below.

In some instances, the processing server 102 may be configured to electronically transmit a data signal to a financial institution associated with each of the individuals in the consumer group 104 to notify the financial institution of the fraudulent transactions. The data signal may be, for example, superimposed with a primary account number or other identifying information associated with the respective transaction account and the calculated fraud score. The financial institution, such as an issuing bank that issued the transaction account being used in the fraudulent transactions, may then freeze the transaction account or take other measures as a result of the indicated fraud. In some embodiments, the processing server 102 may be configured to notify a financial institution only if the fraud score is above a predetermined threshold, such as one set by the respective financial institution.

The methods and systems discussed herein enable the processing server 102 to identify individuals comprising a consumer group 104 based on commonality in payment transactions conducted by the individuals. By using a specifically configured computing system to identify a group of individuals based on the commonality in payment transactions, a group of individuals that regularly transact together may be efficiently identified and the transaction behaviors for the group as a whole also identified. This may be an improvement over traditional methods and systems that are unable to identify groups of consumers, let alone transaction behavior for the group as opposed to individual transaction behavior. Therefore, the processing server 102 may be uniquely suited for the identification of an associated group of individuals and identification of content for the distribution thereto via the specific configuration and performance of the methods discussed herein.

### Processing Server

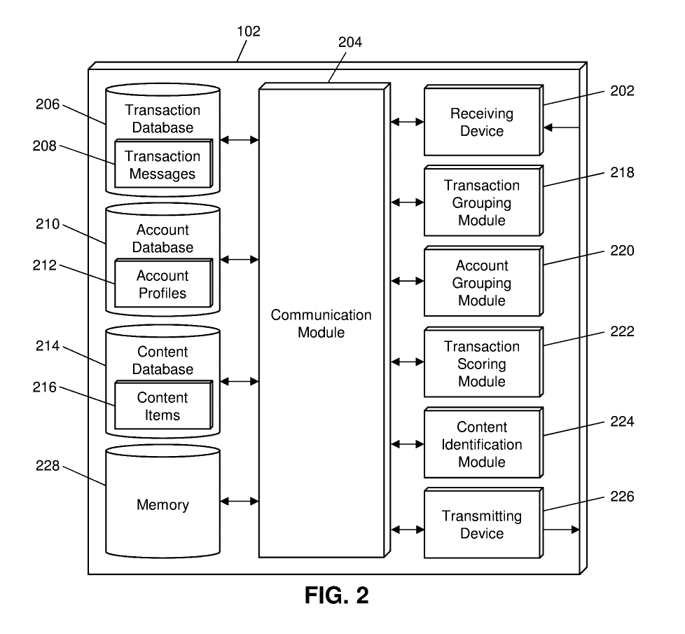

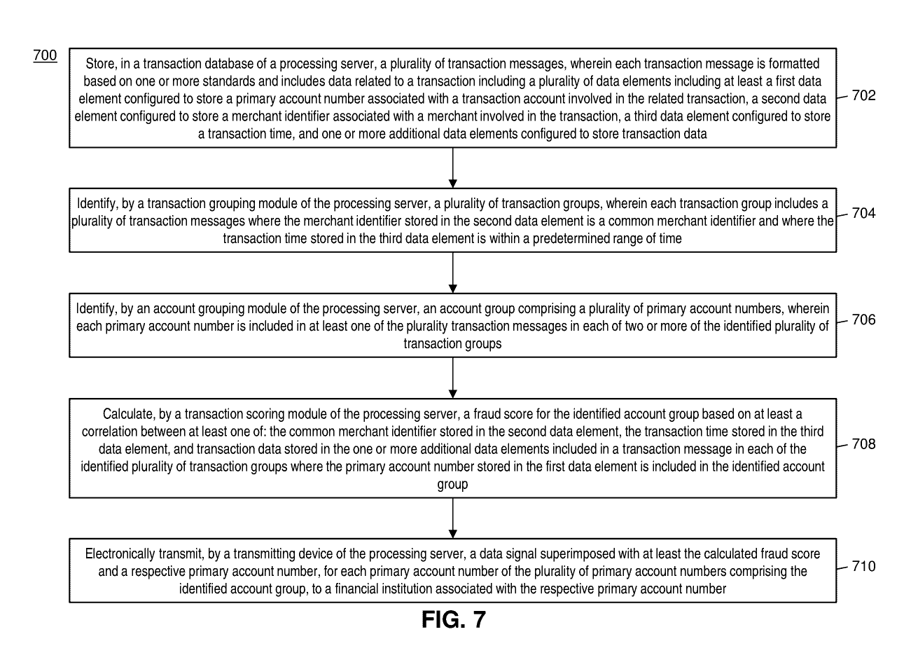

FIG. 2 illustrates an embodiment of the processing server 102 of the system 100. It will be apparent to persons having skill in the relevant art that the embodiment of the processing server 102 illustrated in FIG. 2 is provided as illustration only and may not be exhaustive to all possible configurations of the processing server 102 suitable for performing the functions as discussed herein. For example, the computer system 700 illustrated in FIG. 7 and discussed in more detail below may be a suitable configuration of the processing server 102.

The processing server 102 may include a receiving device 202. The receiving device 202 may be configured to receive data over one or more networks via one or more network protocols. In some embodiments, the receiving device 202 may be configured to receive data over the payment rails, such as using specially configured infrastructure associated with payment networks 108 for the transmission of transaction messages that include sensitive financial data and information. In some instances, the receiving device 202 may also be configured to receive data from consumers 104, merchants 106, payment networks 108, content providers 110, and other entities via alternative networks, such as the Internet. In some embodiments, the receiving device 202 may be comprised of multiple devices, such as different receiving devices for receiving data over different networks, such as a first receiving device for receiving data over payment rails and a second receiving device for receiving data over the Internet. The receiving device 202 may receive electronically data signals that are transmitted, where data may be superimposed on the data signal and decoded, parsed, read, or otherwise obtained via receipt of the data signal by the receiving device 202. In some instances, the receiving device 202 may include a parsing module for parsing the received data signal to obtain the data superimposed thereon. For example, the receiving device 202 may include a parser program configured to receive and transform the received data signal into usable input for the functions performed by the processing device to carry out the methods and systems described herein.

The receiving device 202 may be configured to receive data signals from payment networks 108, which may be electronically transmitted via the payment rails or other suitable communication network, and may be superimposed with or otherwise comprise transaction messages for payment transactions. The receiving device 202 may also be configured to receive data signals from content providers 110. In some instances, the data signals may be superimposed with content to be distributed to individuals in consumer groups 104 identified by the processing server 102. In other instances, the data signals may be superimposed with transaction behavior requests and/or consumer group requests, which may request transaction behaviors for an identified consumer group or may request consumer groups that have specified transaction behaviors. For example, a content provider 110 may want to target a group of consumers with a high propensity to go to a restaurant for lunch in a specific geographic area, which may be indicated in the data signal electronically transmitted by the content provider 110 and received by the receiving device 202.

The processing server 102 may also include a communication module 204. The communication module 204 may be configured to transmit data between modules, engines, databases, memories, and other components of the processing server 102 for use in performing the functions discussed herein. The communication module 204 may be comprised of one or more communication types and utilize various communication methods for communications within a computing device. For example, the communication module 204 may be comprised of a bus, contact pin connectors, wires, etc. In some embodiments, the communication module 204 may also be configured to communicate between internal components of the processing server 102 and external components of the processing server 102, such as externally connected databases, display devices, input devices, etc. The processing server 102 may also include a processing device. The processing device may be configured to perform the functions of the processing server 102 discussed herein as will be apparent to persons having skill in the relevant art. In some embodiments, the processing device may include and/or be comprised of a plurality of engines and/or modules specially configured to perform one or more functions of the processing device, such as a transaction grouping module 218, account grouping module 220, transaction scoring module 222, and content identification module 224. As used herein, the term “module” may be hardware particularly programmed (e.g., either hardwired or via executed software) to receive an input, perform one or more processes using the input, and provide an output. The input, output, and processes performed by various modules will be apparent to one skilled in the art based upon the present disclosure.

In some embodiments, the processing server 102 may include a transaction database 206. The transaction database 206 may be configured to store a plurality of transaction messages 208 using a suitable data storage format and schema. The transaction database 206 may be a relational database that utilizes structured query language for the storage, identification, modifying, updating, accessing, etc. of structured data sets stored therein. Each transaction message 208 may be a structured data set configured to store data related to a payment transaction, and may be formatted pursuant to one or more standards, such as the ISO 8583 standard. Each transaction message 208 may include at least a first data element configured to store a primary account number, a second data element configured to store a merchant identifier, a third data element configured to store a transaction time, and one or more additional data elements configured to store transaction data. The primary account number may be associated with a transaction account used to fund the related payment transaction. The merchant identifier may be a unique value associated with a merchant 106 involved in the related payment transaction, such as a merchant identification number. The transaction time may be a time and/or date at which the related payment transaction was processed. The transaction data stored in the additional data elements may include additional data associated with the related payment transaction suitable for use in the identification of transaction behaviors.

In some embodiments, the processing server 102 may include a querying module. The querying module may be configured to execute queries on databases to identify information. The querying module may receive one or more data values or query strings, and may execute a query string based thereon on an indicated database, such as the transaction database 206, to identify information stored therein. The querying module may then output the identified information to an appropriate engine or module of the processing server 102 as necessary. The querying module may, for example, execute a query on the transaction database 206 to identify transaction messages and/or date stored therein based on criteria provided by another module or engine of the processing server 102, such as the transaction grouping module 218.

The transaction grouping module 218 may be configured to identify a plurality of transaction groups. Each transaction group may be comprised of a plurality of transaction messages 208, wherein each transaction message 208 in the respective group includes a common merchant identifier stored in the second data element and a transaction time stored in the third data element that is within a predetermined period of time. The transaction grouping module 218 may receive an instruction to identify transaction groups as input, which may also include the plurality of transaction messages 208 for grouping, such as if received by the receiving device 202 and not stored in the transaction database 206 or identified therefrom by the querying module. The transaction grouping module 218 may identify the groups and may output the groups of transaction messages for use by another module or engine of the processing server 102, such as the account grouping module 220.

The account grouping module 220 may be configured to identify consumer groups 104 of transaction accounts using the identified transaction groups. The account grouping module 220 may receive the plurality of transaction groups from the transaction grouping module 218 as input, and may identify one or more account groups from the transaction groups. Each account group may be comprised of a plurality of primary account numbers, where each primary account number is stored in the first data element included in at least one transaction message included in each of two or more of the plurality of transaction groups. The account group may therefore include primary account numbers associated with transaction accounts comprising a consumer group 104. The account grouping module 220 may be configured to output the identified account groups for use by another module or engine of the processing server 102, such as the transaction scoring module 222.

The transaction scoring module 222 may be configured to identify transaction behaviors for account groups. The transaction scoring module 222 may receive an account group of primary account numbers as input, and may also receive the plurality of transaction groups or associated payment transactions. The transaction scoring module 222 may be configured to identify one or more purchase behaviors based on the transaction data stored in the additional data elements included in each of the transaction messages from the plurality of transaction groups that include a first data element that stores one of the primary account numbers included in the account group. The transaction scoring module 222 may output the identified one or more purchase behaviors for the account group for use by another module or engine of the processing server 102, such as the content identification module 224 or the transmitting device 226.

The transaction scoring module 222 may also be configured to calculate fraud scores for account groups. The transaction scoring module 222 may receive an account group of primary account numbers as input, and may also receive the plurality of transaction groups or associated payment transactions. The transaction scoring module 222 may calculate a fraud score based on application of one or more fraud scoring algorithms to the transaction data stored in the transaction messages for the associated payment transactions. In some instances, the transaction scoring module 222 may calculate a separate fraud score for each primary account number in the account group. The transaction scoring module 222 may output the fraud score for use by another module or engine of the processing server 102, such as the transmitting device 226.

The transmitting device 226 may be configured to transmit data over one or more networks via one or more network protocols. In some embodiments, the transmitting device 226 may be configured to transmit data over the payment rails, such as using specially configured infrastructure associated with payment networks 107 for the transmission of transaction messages that include sensitive financial data and information, such as identified payment credentials. In some instances, the transmitting device 226 may be configured to transmit data to consumer groups 104, merchants 106, payment networks 108, content providers 110, and other entities via alternative networks, such as the Internet. In some embodiments, the transmitting device 226 may be comprised of multiple devices, such as different transmitting devices for transmitting data over different networks, such as a first transmitting device for transmitting data over the payment rails and a second transmitting device for transmitting data over the Internet. The transmitting device 226 may electronically transmit data signals that have data superimposed that may be parsed by a receiving computing device. In some instances, the transmitting device 226 may include one or more modules for superimposing, encoding, or otherwise formatting data into data signals suitable for transmission.

The transmitting device 226 may be configured to electronically transmit data signals to payment networks 108 and content providers 110 superimposed with requests for data. For example, the transmitting device 226 may transmit a request for transaction messages to the payment network 108, such as to request transaction messages for a consumer group 104 or use in updating associated transaction behaviors. The transmitting device 226 may also electronically transmit a data signal to a content provider 110 that is superimposed with a content request. The content request may include the one or more transaction behaviors identified for an account group by the transaction scoring module 226, which may be used by the content provider 110 in the identification of content. In some embodiments, the content provider 110 may provide the identified content to the processing server 102 (e.g., via the receiving device 202), which may be electronically transmitted to the consumer group 104 via the transmitting device 226 using suitable methods and communication protocols. The transmitting device 226 may also be configured to electronically transmit data signals to financial institutions, such as issuing banks, that are superimposed with fraud scores. For instance, the transmitting device 226 may electronically transmit a data signal superimposed with a fraud score calculated for an account group and a primary account number included in the account group to a financial institution associated with the primary account number.

In some embodiments, the processing server 102 may also include an account database 210. The account database 210 may be configured to store a plurality of account profiles 212 using a suitable data storage format and schema. The account database 210 may be a relational database that utilizes structured query language for the storage, identification, modifying, updating, accessing, etc. of structured data sets stored therein. Each account profile 212 may be a structured data set configured to store data related to a transaction account. Each account profile 212 may include, for instance, a primary account number associated with the transaction account and communication information. The communication information may include information suitable for use in the distribution of content to an individual associated with the related transaction account, such as a communication method and address. For example, the communication information may include an e-mail address or a device identifier for a computing device. In some instances, an account profile 212 may also include data associated with a consumer group 104 that includes the related transaction account, such as a primary account number or group identification number or other value associated with the consumer group 104.

In some embodiments, the processing server 102 may also include a content database 214. The content database 214 may be configured to store a plurality of content items 216 using a suitable data storage format and schema. The content database 214 may be a relational database that utilizes structured query language for the storage, identification, modifying, updating, accessing, etc. of structured data sets stored therein. Each content item 216 may be a data file, reference address, or other piece of data that comprises or is otherwise associated with content to be distributed to consumers via suitable computing devices and systems. Each content item 216 may also be associated with one or more purchase behaviors. Content items 216 stored in the content database 214 may be received by the receiving device 202 via data signals electronically transmitted by the content provider 110 using a suitable communication network.

In such embodiments, the processing server 102 may also include a content identification module 224. The content identification module 224 may be configured to identify one or more content items 216 for distribution to individuals in a consumer group 104 based on the associated transaction behaviors. The content identification module 224 may receive the one or more transaction behaviors identified by the transaction scoring module 222, and may instruct the querying module to query the content database 214 to identify one or more content items 216 that are associated with transaction behaviors also identified for the consumer group 104. The content identification module 224 may output the identified content to the transmitting device 226 for transmitting to the consumer group 104 (e.g., using the communication information stored in the associated account profiles 212) or the content provider 110 for distribution to the consumer group 104.

The processing server 102 may also include a memory 224. The memory 224 may be configured to store data for use by the processing server 102 in performing the functions discussed herein. The memory 224 may be configured to store data using suitable data formatting methods and schema and may be any suitable type of memory, such as read-only memory, random access memory, etc. The memory 224 may include, for example, encryption keys and algorithms, communication protocols and standards, data formatting standards and protocols, program code for modules and application programs of the processing device, and other data that may be suitable for use by the processing server 102 in the performance of the functions disclosed herein as will be apparent to persons having skill in the relevant art.

### Process for Distributing Content to Identified Groups of Associated Individuals

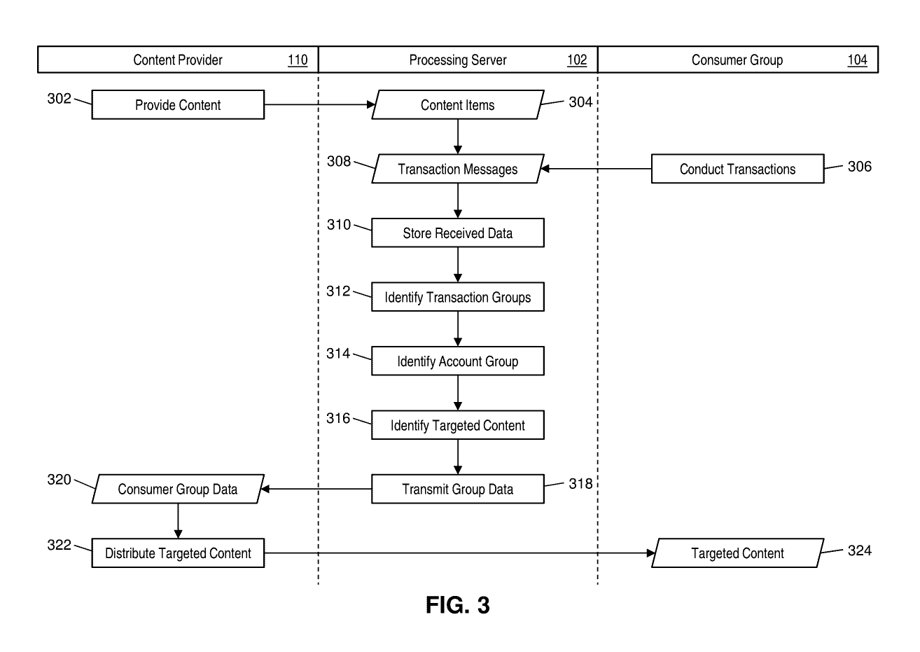

FIG. 3 illustrates a process for the identification and distribution of content based on transaction behaviors for a group of associated individuals identified based on commonality in payment transactions.

In step 302, the content provider 110 may electronically transmit data signals to the processing server 102 superimposed with content items. In step 304, the receiving device 202 of the processing server 102 may receive the content items from the content provider 110, which may be stored in the content database 214 of the processing server 102 as content items 216. Each content item may be associated with one or more transaction behaviors.

In step 306, individuals in the consumer group 104 may each conduct payment transactions at a plurality of merchants 106. Each payment transaction may be funded by a transaction account associated with the respective individual, which may be associated with a specific primary account number that is included in the transaction message related to the payment transaction. In step 308, the receiving device 202 of the processing server 102 may receive transaction messages for each of the payment transactions involving the individuals in the consumer group 104. Each transaction message may include data elements configured to store a primary account number, a merchant identifier, a transaction time, and additional transaction data. In step 310, the received transaction messages may be stored in the transaction database 206 of the processing server 102 as transaction messages 208.

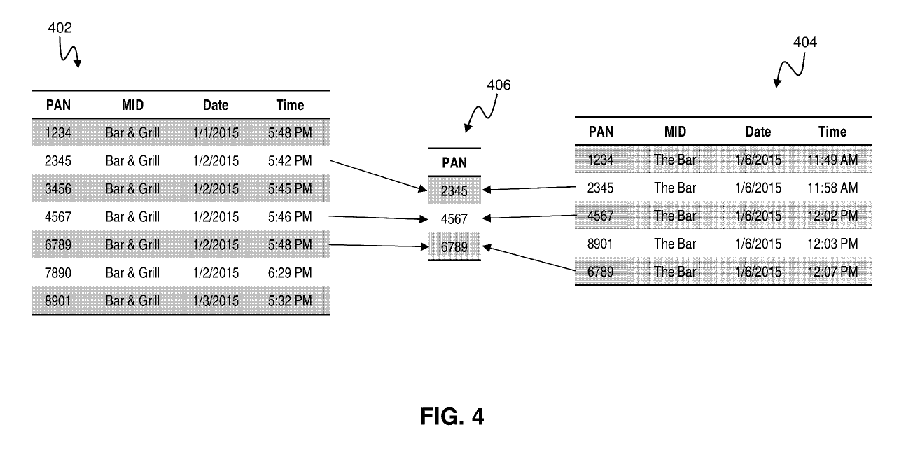

In step 312, the transaction grouping module 218 of the processing server 102 may identify a plurality of transaction groups. Each transaction group may include a plurality of transaction messages 208, where the data elements included in each transaction message 208 in the group stores a common merchant identifier and a transaction time that is within a predetermined period of time. In step 314, the account grouping module 220 of the processing server 102 may identify an account group from the plurality of transaction groups. The account group may be a group of primary account numbers where each primary account number is stored in a corresponding data element in a transaction message in each of two or more of the plurality of transaction groups. Additional details regarding the identification of an account group are illustrated in FIG. 4 and discussed in more detail below.

In step 316, targeted content may be identified for distribution to the consumer group 104 that corresponds to the identified account group. The identification of targeted content may include the identification of transaction behaviors for the account group by the transaction scoring module 222 of the processing server, which may identify one or more transaction behaviors based on the transaction data stored in the data elements included in each transaction message in the plurality of transaction groups that includes a primary account number included in the account group, and the identification of one or more content items 216 associated with the same one or more transaction behaviors.

In step 318, the transmitting device 226 of the processing server 102 may electronically transmit data associated with the consumer group 104 and identified content to the content provider 110. The data may include, for example, an identifier associated with the identified content items 216 as well as communication information or other identifying information associated with each individual in the consumer group 104, such as may be identified in the account profiles 212 in the account database 210 related to the transaction accounts associated with the primary account numbers included in the identified account group. In step 320, the content provider 110 may receive the consumer group data and, in step 322, may distribute the targeted content to each individual in the consumer group 104 using traditional methods and systems. In step 324, the individuals in the consumer group 104 may receive the targeted content.

### Identification of an Associated Group of Individuals

FIG. 4 illustrates the identification of an associated group of individuals based on commonality in transaction data related to payment transactions involving the group of individuals.

As illustrated in FIG. 4, a first set of transactions 402 includes transaction data stored in seven different transaction messages. The transaction data for each transaction message includes a primary account number (PAN), a merchant identifier (MID), a transaction date, and a transaction time. In the illustrated example, each of the seven transaction messages in the first set of transactions 402 involves the same merchant 106, Bar & Grill. A second set of transactions 404 includes the same transaction data for each of transaction message related to five different payment transactions. In the illustrated example, each of the five transaction messages in the second set of transactions 404 involves the same merchant 106, The Bar.

The transaction grouping module 218 may identify a group of transactions from the first set of transactions 402 and the second set of transactions 404. In the first set of transactions 402, the transaction group may include four of the transaction messages that include a transaction date of Jan. 2, 2015 and a transaction time between 5:42 PM and 5:48 PM, with the other transaction message not included in the group because of the difference in time and/or date. In the second set of transactions 404, the transaction group may include each of the transactions due to the commonality in the merchant identifier and the transaction time and date being within a predetermined period of time (e.g., within 20 minutes).

The transaction grouping module 218 may operate by iterating through the first set of transactions 402. The transaction grouping module 218 may start at the first transaction in the set (e.g., with PAN 1234) and may compare the transaction with each of the remaining transactions in the set to determine if the transaction time is within a predetermined period of time. For each transaction that is matched (e.g., has a time within the predetermined period of time), the transaction grouping module 218 may register an interaction between each of the respective PANs. The transaction grouping module 218 may then proceed to the next transaction in the set, and continue iterating until each transaction has been compared to each other transaction in the set, where the resulting registered data of interactions may comprise a transaction group. The transaction grouping module 218 may then repeat the process for the second set of transactions 404 to identify a second transaction group.

The account grouping module 220 of the processing server 102 may identify an account group 406 from the two transaction groups. The account group 406 may include primary account numbers that are included in transaction messages in both of the transaction groups. In the illustrated example, the account group 406 includes three PANs that are each included in one of the transaction messages in both transaction groups. As a result, the three PANs represent three transaction accounts corresponding to three individuals that are likely to transact together as a consumer group 104.

The account grouping module 220 may operate by identifying each of the registered interactions between PANs across each (e.g., in the illustrated example, two) of the transaction groups. The account grouping module 220 may identify an account group where each PAN in the account group is included in interactions in each of the transaction groups. In instances where there may be more than two transaction groups, the number of interactions may be equal to the number of transaction groups, a majority of transaction groups, or a predetermined number of transaction groups. In some instances, the account grouping module 220 may also consider additional criteria, such as a location or date count of interactions. For example, the account grouping module 220 may not group two PANs together that have multiple interactions if each interaction is at the same location (e.g., where two individuals may inadvertently visit the same place for lunch regularly) or occurs on the same day (e.g., where two individuals may inadvertently shop at the same merchants in a shopping mall on the same day).

### Identifying Content or Fraudulent Transactions for an Associated Group of Individuals

FIG. 5 illustrates a process 500 for the identification of content or fraudulent transactions for an associated group of individuals identified based on commonality in transaction data for each of the individuals.

In step 502, a plurality of transaction messages 208 may be stored in a transaction database 206 of the processing server 102. Each transaction message 208 may be formatted based on one or more standards, such as the ISO 8583 standard, and include a plurality of data elements configured to store a primary account number, a merchant identifier, a transaction time, and additional transaction data. In step 504, the transaction grouping module 218 of the processing server 102 may be configured to identify a plurality of transaction groups where the merchant identifier stored in transaction messages in each respective transaction group is a common merchant identifier and where the respective transaction time is within a predetermined period of time. In step 506, the account grouping module 220 of the processing server 102 may identify an account group that is comprised of a plurality of primary account numbers where each primary account number is included in a transaction message in two or more of the identified transaction groups.

Once the account group has been identified, then, in step 508, a module of the processing server 102 may determine if there is a past relationship between the individuals (e.g., associated with the primary account numbers) included in the account group. A past relationship may be identified based on, for instance, the transaction time included in the transaction messages in each of the transaction groups that include transactions involving the individuals in the account group. For example, if the transaction groups include transaction times that occur on multiple dates or outside of a predetermined time period, then a past relationship may be determined. For instance, an account group of individuals that transact together regularly over a period of weeks or that have transacted a month apart may have a past relationship in that fraud may not be indicated by the pattern of transactions.

If a past relationship is identified, then, in step 510, the transaction scoring module 222 of the processing server 102 may identify purchase behaviors for the account group. The purchase behaviors may be based on the transaction data stored in the data elements included in each transaction message in the plurality of transaction groups that includes a primary account number included in the account group. In step 512, the content identification module 224 of the processing server 102 may identify a content item based on the identified purchase behaviors. In step 514, the transmitting device 226 of the processing server 102 may electronically transmit a data signal superimposed with the identified content item, such as to a computing device associated with each of the primary account numbers or to a third party entity (e.g., the content provider 110) for distribution of the content item to individuals associated with the primary account numbers in the account group.

If, in step 508, a past relationship between the individuals in the account group is not identified, then, in step 516, the transaction scoring module 222 of the processing server 102 may calculate a fraud score for the account group. The fraud score may be based on a correlation between at least one of: the common merchant identifier, the transaction time, and the transaction data stored in one or more transaction messages in each of the transaction groups that involve the primary account numbers comprising the account group. The fraud score may be calculated based on the application of one or more fraud algorithms to the transaction data that utilizes such correlations. In step 518, a suitable module or engine of the processing server 102 may determine if the calculated fraud score is above a predetermined threshold. The predetermined threshold may be set by the processing server 102 or by a financial institution to which the fraud score is to be transmitted. If the fraud score is not above the predetermined threshold, then the process 500 may be completed as fraud may thus not be indicated by the transactions. If the fraud score is above the predetermined threshold, then, in step 520, the transmitting device 226 of the processing server 102 may electronically transmit a data signal to each financial institution associated with a primary account number included in the account group, where the data signal is superimposed with at least the respective primary account number and the calculated fraud score. The financial institutions may then determine if fraud is occurring and may take appropriate actions accordingly.

### Exemplary Method for Identifying Content for an Associated Group of Individuals

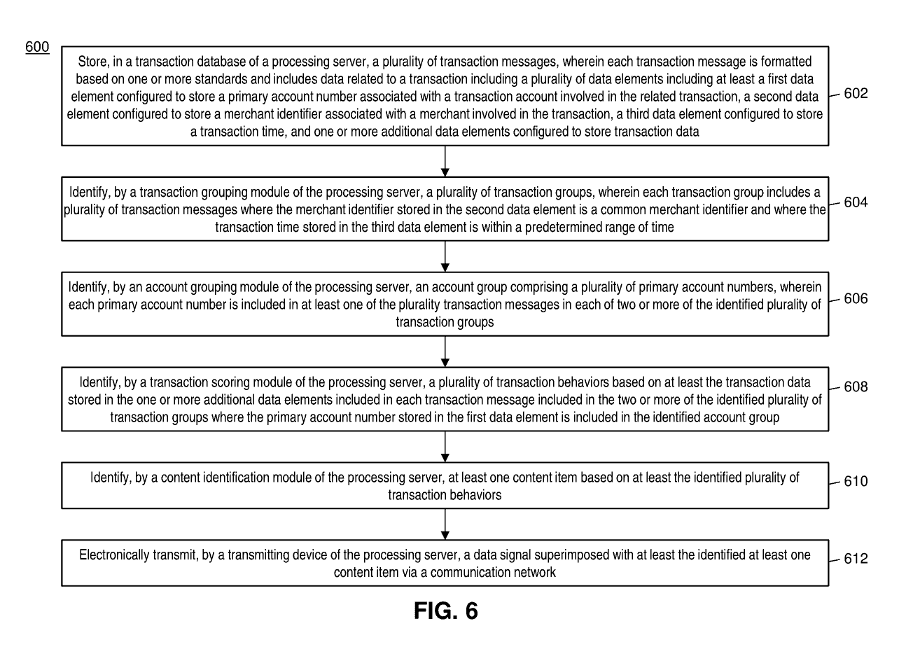

FIG. 6 illustrates a method 600 for the identification of content for an associated group of individuals identified based on captured transaction messages.

In step 602, a plurality of transaction messages (e.g., transaction messages 208) may be stored in a transaction database (e.g., the transaction database 206) of a processing server (e.g., the processing server 102), wherein each transaction message is formatted based on one or more standards and includes data related to a transaction including a plurality of data elements including at least a first data element configured to store a primary account number associated with a transaction account involved in the related transaction, a second data element configured to store a merchant identifier associated with a merchant (e.g., a merchant 106) involved in the transaction, a third data element configured to store a transaction time, and one or more additional data elements configured to store transaction data. In step 604, a plurality of transaction groups may be identified by a transaction grouping module (e.g., the transaction grouping module 218) of the processing server, wherein each transaction group includes a plurality of transaction messages where the merchant identifier stored in the second data element is a common merchant identifier and where the transaction time stored in the third data element is within a predetermined range of time.

In step 606, an account group comprising a plurality of primary account numbers may be identified by an account grouping module (e.g., the account grouping module 220) of the processing server, wherein each primary account number is included in at least one of the plurality transaction messages in each of two or more of the identified plurality of transaction groups. In step 608, a plurality of transaction behaviors may be identified by a transaction scoring module (e.g., the transaction scoring module 222) of the processing server based on at least the transaction data stored in the one or more additional data elements included in each transaction message included in the two or more of the identified plurality of transaction groups where the primary account number stored in the first data element is included in the identified account group.

In step 610, at least one content item (e.g., content item 216) may be identified by a content identification module (e.g., the content identification module 224) of the processing server based on at least the identified plurality of transaction behaviors. In step 612, a data signal superimposed with at least the identified at least one content item may be electronically transmitted by a transmitting device (e.g., the transmitting device 226) of the processing server via a communication network.

In one embodiment, the method 600 may further include: storing, in an account database (e.g., the account database 210) of the processing server, a plurality of account profiles (e.g., account profiles 212), wherein each account profile includes data related to a transaction account including at least an account number and contact information; and executing, by a querying module of the processing server, a query on the account database to identify, for each primary account number included in the identified account group, a related account profile where the included account number corresponds to the respective primary account number. In a further embodiment, the electronically transmitted data signal may be further superimposed with the contact information stored in the related account profile identified for each primary account number included in the identified account group. In another further embodiment, the electronically transmitted data signal may be transmitted to a computing device associated with each related account profile identified for each primary account number included in the identified account group based on the included contact information.

In some embodiments, the identified at least one content item may be an offer associated with a transaction and include at least an offer value. In a further embodiment, the offer value may be based on a number of the primary account numbers included in the identified transaction group. In another further embodiment, the method 600 may also include: receiving, by a receiving device of the processing server, a data signal superimposed with an acceptance notification indicating acceptance of the offer including at least one of the primary account numbers included in the identified transaction group; and increasing, by a value calculation module, the offer value.

In one embodiment, identifying the at least one content item may comprise: electronically transmitting, by the transmitting device of the processing server, a data signal superimposed with at least the identified plurality of transaction behaviors to a content provider; and receiving, by the receiving device of the processing server, a data signal from the content provider superimposed with the at least one content item. In some embodiments, the method 600 may further include storing, in a content database (e.g., the content database 214) of the processing server, a plurality of content items, each content item being associated with one or more transaction behaviors, wherein identifying the at least one content item includes executing, by a querying module of the processing server, a query on the content database to identify the at least one content item based on a correspondence between the associated one or more transaction behaviors and the identified plurality of transaction behaviors. In one embodiment, the plurality of transaction behaviors may include at least one of: a propensity to conduct a transaction involving a specific merchant, a specific merchant industry, a specific product, a specific product category, a specific geographic location, a specific geographic area, or a specific transaction amount range; a propensity to conduct a transaction at a specific time, during a specific time range, on a specific day, on a specific day of week, during a specific date range, or during a specific month; a transaction frequency; an average ticket size; and a number of transactions.

### Exemplary Method for Identifying Fraudulent Transactions Based on Individual Relationships

FIG. 7 illustrates a method 700 for the identification of fraudulent actions involving a group of individuals based on transactional relationships between the individuals.

In step 702, a plurality of transaction messages (e.g., transaction messages 208) may be stored in a transaction database (e.g., the transaction database 206) of a processing server (e.g., the processing server 102), wherein each transaction message is formatted based on one or more standards and includes data related to a transaction including a plurality of data elements including at least a first data element configured to store a primary account number associated with a transaction account involved in the related transaction, a second data element configured to store a merchant identifier associated with a merchant (e.g., a merchant 106) involved in the transaction, a third data element configured to store a transaction time, and one or more additional data elements configured to store transaction data. In step 704, a plurality of transaction groups may be identified by a transaction grouping module (e.g., the transaction grouping module 218) of the processing server, wherein each transaction group includes a plurality of transaction messages where the merchant identifier stored in the second data element is a common merchant identifier and where the transaction time stored in the third data element is within a predetermined range of time.

In step 706, an account group comprising a plurality of primary account numbers may be identified by an account grouping module (e.g., the account grouping module 220) of the processing server, wherein each primary account number is included in at least one of the plurality transaction messages in each of two or more of the identified plurality of transaction groups. In step 708, a fraud score may be calculated by a transaction scoring module (e.g., the transaction scoring module 222) of the processing server for the identified account group based on at least a correlation between at least one of: the common merchant identifier stored in the second data element, the transaction time stored in the third data element, and transaction data stored in the one or more additional data elements included in a transaction message in each of the identified plurality of transaction groups where the primary account number stored in the first data element is included in the identified account group.

In step 710, a data signal superimposed with at least the calculated fraud score and a respective primary account number, for each primary account number of the plurality of primary account numbers comprising the identified account group, may be electronically transmitted by a transmitting device (e.g., the transmitting device 226) of the processing server to a financial institution associated with the respective primary account number. In one embodiment, the data signal may be electronically transmitted to the financial institution if the calculated fraud score is above a predetermined threshold associated with the financial institution.

### Payment Transaction Processing System and Process

FIG. 8 illustrates a transaction processing system and a process 800 for the processing of payment transactions in the system. The process 800 and steps included therein may be performed by one or more components of the system 100 discussed above, such as the processing server 102, merchants 108, payment network 108, etc. The processing of payment transactions using the system and process 800 illustrated in FIG. 8 and discussed below may utilize the payment rails, which may be comprised of the computing devices and infrastructure utilized to perform the steps of the process 800 as specially configured and programmed by the entities discussed below, including the transaction processing server 812, which may be associated with one or more payment networks configured to processing payment transactions. It will be apparent to persons having skill in the relevant art that the process 800 may be incorporated into the processes illustrated in FIGS. 3 and 5-7, discussed above, with respect to the step or steps involved in the processing of a payment transaction. In addition, the entities discussed herein for performing the process 800 may include one or more computing devices or systems configured to perform the functions discussed below. For instance, the merchant 806 may be comprised of one or more point of sale devices, a local communication network, a computing server, and other devices configured to perform the functions discussed below.

In step 820, an issuing financial institution 802 may issue a payment card or other suitable payment instrument to a consumer 804. The issuing financial institution may be a financial institution, such as a bank, or other suitable type of entity that administers and manages payment accounts and/or payment instruments for use with payment accounts that can be used to fund payment transactions. The consumer 804 may have a transaction account with the issuing financial institution 802 for which the issued payment card is associated, such that, when used in a payment transaction, the payment transaction is funded by the associated transaction account. In some embodiments, the payment card may be issued to the consumer 804 physically. In other embodiments, the payment card may be a virtual payment card or otherwise provisioned to the consumer 804 in an electronic format.

In step 822, the consumer 804 may present the issued payment card to a merchant 806 for use in funding a payment transaction. The merchant 806 may be a business, another consumer, or any entity that may engage in a payment transaction with the consumer 804. The payment card may be presented by the consumer 804 via providing the physical card to the merchant 806, electronically transmitting (e.g., via near field communication, wireless transmission, or other suitable electronic transmission type and protocol) payment details for the payment card, or initiating transmission of payment details to the merchant 806 via a third party. The merchant 806 may receive the payment details (e.g., via the electronic transmission, via reading them from a physical payment card, etc.), which may include at least a transaction account number associated with the payment card and/or associated transaction account. In some instances, the payment details may include one or more application cryptograms, which may be used in the processing of the payment transaction.

In step 824, the merchant 806 may enter transaction details into a point of sale computing system. The transaction details may include the payment details provided by the consumer 804 associated with the payment card and additional details associated with the transaction, such as a transaction amount, time and/or date, product data, offer data, loyalty data, reward data, merchant data, consumer data, point of sale data, etc. Transaction details may be entered into the point of sale system of the merchant 806 via one or more input devices, such as an optical bar code scanner configured to scan product bar codes, a keyboard configured to receive product codes input by a user, etc. The merchant point of sale system may be a specifically configured computing device and/or special purpose computing device intended for the purpose of processing electronic financial transactions and communicating with a payment network (e.g., via the payment rails). The merchant point of sale system may be an electronic device upon which a point of sale system application is run, wherein the application causes the electronic device to receive and communicated electronic financial transaction information to a payment network. In some embodiments, the merchant 806 may be an online retailer in an e-commerce transaction. In such embodiments, the transaction details may be entered in a shopping cart or other repository for storing transaction data in an electronic transaction as will be apparent to persons having skill in the relevant art.

In step 826, the merchant 806 may electronically transmit a data signal superimposed with transaction data to a gateway processor 808. The gateway processor 808 may be an entity configured to receive transaction details from a merchant 806 for formatting and transmission to an acquiring financial institution 810. In some instances, a gateway processor 808 may be associated with a plurality of merchants 806 and a plurality of acquiring financial institutions 810. In such instances, the gateway processor 808 may receive transaction details for a plurality of different transactions involving various merchants, which may be forwarded on to appropriate acquiring financial institutions 810. By having relationships with multiple acquiring financial institutions 810 and having the requisite infrastructure to communicate with financial institutions using the payment rails, such as using application programming interfaces associated with the gateway processor 808 or financial institutions used for the submission, receipt, and retrieval of data, a gateway processor 808 may act as an intermediary for a merchant 806 to be able to conduct payment transactions via a single communication channel and format with the gateway processor 808, without having to maintain relationships with multiple acquiring financial institutions 810 and payment processors and the hardware associated thereto. Acquiring financial institutions 810 may be financial institutions, such as banks, or other entities that administers and manages payment accounts and/or payment instruments for use with payment accounts. In some instances, acquiring financial institutions 810 may manage transaction accounts for merchants 806. In some cases, a single financial institution may operate as both an issuing financial institution 802 and an acquiring financial institution 810.

The data signal transmitted from the merchant 806 to the gateway processor 808 may be superimposed with the transaction details for the payment transaction, which may be formatted based on one or more standards. In some embodiments, the standards may be set forth by the gateway processor 808, which may use a unique, proprietary format for the transmission of transaction data to/from the gateway processor 808. In other embodiments, a public standard may be used, such as the International Organization for Standardization's ISO 8883 standard. The standard may indicate the types of data that may be included, the formatting of the data, how the data is to be stored and transmitted, and other criteria for the transmission of the transaction data to the gateway processor 808.

In step 828, the gateway processor 808 may parse the transaction data signal to obtain the transaction data superimposed thereon and may format the transaction data as necessary. The formatting of the transaction data may be performed by the gateway processor 808 based on the proprietary standards of the gateway processor 808 or an acquiring financial institution 810 associated with the payment transaction. The proprietary standards may specify the type of data included in the transaction data and the format for storage and transmission of the data. The acquiring financial institution 810 may be identified by the gateway processor 808 using the transaction data, such as by parsing the transaction data (e.g., deconstructing into data elements) to obtain an account identifier included therein associated with the acquiring financial institution 810. In some instances, the gateway processor 808 may then format the transaction data based on the identified acquiring financial institution 810, such as to comply with standards of formatting specified by the acquiring financial institution 810. In some embodiments, the identified acquiring financial institution 810 may be associated with the merchant 806 involved in the payment transaction, and, in some cases, may manage a transaction account associated with the merchant 806.

In step 830, the gateway processor 808 may electronically transmit a data signal superimposed with the formatted transaction data to the identified acquiring financial institution 810. The acquiring financial institution 810 may receive the data signal and parse the signal to obtain the formatted transaction data superimposed thereon. In step 832, the acquiring financial institution may generate an authorization request for the payment transaction based on the formatted transaction data. The authorization request may be a specially formatted transaction message that is formatted pursuant to one or more standards, such as the ISO 8883 standard and standards set forth by a payment processor used to process the payment transaction, such as a payment network. The authorization request may be a transaction message that includes a message type indicator indicative of an authorization request, which may indicate that the merchant 806 involved in the payment transaction is requesting payment or a promise of payment from the issuing financial institution 802 for the transaction. The authorization request may include a plurality of data elements, each data element being configured to store data as set forth in the associated standards, such as for storing an account number, application cryptogram, transaction amount, issuing financial institution 802 information, etc.

In step 834, the acquiring financial institution 810 may electronically transmit the authorization request to a transaction processing server 812 for processing. The transaction processing server 812 may be comprised of one or more computing devices as part of a payment network configured to process payment transactions. In some embodiments, the authorization request may be transmitted by a transaction processor at the acquiring financial institution 810 or other entity associated with the acquiring financial institution. The transaction processor may be one or more computing devices that include a plurality of communication channels for communication with the transaction processing server 812 for the transmission of transaction messages and other data to and from the transaction processing server 812. In some embodiments, the payment network associated with the transaction processing server 812 may own or operate each transaction processor such that the payment network may maintain control over the communication of transaction messages to and from the transaction processing server 812 for network and informational security.

In step 836, the transaction processing server 812 may perform value-added services for the payment transaction. Value-added services may be services specified by the issuing financial institution 802 that may provide additional value to the issuing financial institution 802 or the consumer 804 in the processing of payment transactions. Value-added services may include, for example, fraud scoring, transaction or account controls, account number mapping, offer redemption, loyalty processing, etc. For instance, when the transaction processing server 812 receives the transaction, a fraud score for the transaction may be calculated based on the data included therein and one or more fraud scoring algorithms and/or engines. In some instances, the transaction processing server 812 may first identify the issuing financial institution 802 associated with the transaction, and then identify any services indicated by the issuing financial institution 802 to be performed. The issuing financial institution 802 may be identified, for example, by data included in a specific data element included in the authorization request, such as an issuer identification number. In another example, the issuing financial institution 802 may be identified by the primary account number stored in the authorization request, such as by using a portion of the primary account number (e.g., a bank identification number) for identification.

In step 838, the transaction processing server 812 may electronically transmit the authorization request to the issuing financial institution 802. In some instances, the authorization request may be modified, or additional data included in or transmitted accompanying the authorization request as a result of the performance of value-added services by the transaction processing server 812. In some embodiments, the authorization request may be transmitted to a transaction processor (e.g., owned or operated by the transaction processing server 812) situated at the issuing financial institution 802 or an entity associated thereof, which may forward the authorization request to the issuing financial institution 802.

In step 840, the issuing financial institution 802 may authorize the transaction account for payment of the payment transaction. The authorization may be based on an available credit amount for the transaction account and the transaction amount for the payment transaction, fraud scores provided by the transaction processing server 812, and other considerations that will be apparent to persons having skill in the relevant art. The issuing financial institution 802 may modify the authorization request to include a response code indicating approval (e.g., or denial if the transaction is to be denied) of the payment transaction. The issuing financial institution 802 may also modify a message type indicator for the transaction message to indicate that the transaction message is changed to be an authorization response. In step 842, the issuing financial institution 802 may transmit (e.g., via a transaction processor) the authorization response to the transaction processing server 812.

In step 844, the transaction processing server 812 may forward the authorization response to the acquiring financial institution 810 (e.g., via a transaction processor). In step 846, the acquiring financial institution may generate a response message indicating approval or denial of the payment transaction as indicated in the response code of the authorization response, and may transmit the response message to the gateway processor 808 using the standards and protocols set forth by the gateway processor 808. In step 848, the gateway processor 808 may forward the response message to the merchant 806 using the appropriate standards and protocols. In step 880, the merchant 806 may then provide the products purchased by the consumer 804 as part of the payment transaction to the consumer 804.

In some embodiments, once the process 800 has completed, payment from the issuing financial institution 802 to the acquiring financial institution 810 may be performed. In some instances, the payment may be made immediately or within one business day. In other instances, the payment may be made after a period of time, and in response to the submission of a clearing request from the acquiring financial institution 810 to the issuing financial institution 802 via the transaction processing server 802. In such instances, clearing requests for multiple payment transactions may be aggregated into a single clearing request, which may be used by the transaction processing server 812 to identify overall payments to be made by whom and to whom for settlement of payment transactions.

In some instances, the system may also be configured to perform the processing of payment transactions in instances where communication paths may be unavailable. For example, if the issuing financial institution is unavailable to perform authorization of the transaction account (e.g., in step 840), the transaction processing server 812 may be configured to perform authorization of transactions on behalf of the issuing financial institution 802. Such actions may be referred to as “stand-in processing,” where the transaction processing server “stands in” as the issuing financial institution 802. In such instances, the transaction processing server 812 may utilize rules set forth by the issuing financial institution 802 to determine approval or denial of the payment transaction, and may modify the transaction message accordingly prior to forwarding to the acquiring financial institution 810 in step 844. The transaction processing server 812 may retain data associated with transactions for which the transaction processing server 812 stands in, and may transmit the retained data to the issuing financial institution 802 once communication is reestablished. The issuing financial institution 802 may then process transaction accounts accordingly to accommodate for the time of lost communication.

In another example, if the transaction processing server 812 is unavailable for submission of the authorization request by the acquiring financial institution 810, then the transaction processor at the acquiring financial institution 810 may be configured to perform the processing of the transaction processing server 812 and the issuing financial institution 802. The transaction processor may include rules and data suitable for use in making a determination of approval or denial of the payment transaction based on the data included therein. For instance, the issuing financial institution 802 and/or transaction processing server 812 may set limits on transaction type, transaction amount, etc. that may be stored in the transaction processor and used to determine approval or denial of a payment transaction based thereon. In such instances, the acquiring financial institution 810 may receive an authorization response for the payment transaction even if the transaction processing server 812 is unavailable, ensuring that transactions are processed and no downtime is experienced even in instances where communication is unavailable. In such cases, the transaction processor may store transaction details for the payment transactions, which may be transmitted to the transaction processing server 812 (e.g., and from there to the associated issuing financial institutions 802) once communication is reestablished.

In some embodiments, transaction processors may be configured to include a plurality of different communication channels, which may utilize multiple communication cards and/or devices, to communicate with the transaction processing server 812 for the sending and receiving of transaction messages. For example, a transaction processor may be comprised of multiple computing devices, each having multiple communication ports that are connected to the transaction processing server 812. In such embodiments, the transaction processor may cycle through the communication channels when transmitting transaction messages to the transaction processing server 812, to alleviate network congestion and ensure faster, smoother communications. Furthermore, in instances where a communication channel may be interrupted or otherwise unavailable, alternative communication channels may thereby be available, to further increase the uptime of the network.

In some embodiments, transaction processors may be configured to communicate directly with other transaction processors. For example, a transaction processor at an acquiring financial institution 810 may identify that an authorization request involves an issuing financial institution 802 (e.g., via the bank identification number included in the transaction message) for which no value-added services are required. The transaction processor at the acquiring financial institution 810 may then transmit the authorization request directly to the transaction processor at the issuing financial institution 802 (e.g., without the authorization request passing through the transaction processing server 812), where the issuing financial institution 802 may process the transaction accordingly.

The methods discussed above for the processing of payment transactions that utilize multiple methods of communication using multiple communication channels, and includes fail safes to provide for the processing of payment transactions at multiple points in the process and at multiple locations in the system, as well as redundancies to ensure that communications arrive at their destination successfully even in instances of interruptions, may provide for a robust system that ensures that payment transactions are always processed successfully with minimal error and interruption. This advanced network and its infrastructure and topology may be commonly referred to as “payment rails,” where transaction data may be submitted to the payment rails from merchants at millions of different points of sale, to be routed through the infrastructure to the appropriate transaction processing servers 812 for processing. The payment rails may be such that a general purpose computing device may be unable to properly format or submit communications to the rails, without specialized programming and/or configuration. Through the specialized purposing of a computing device, the computing device may be configured to submit transaction data to the appropriate entity (e.g., a gateway processor 808, acquiring financial institution 810, etc.) for processing using this advanced network, and to quickly and efficiently receive a response regarding the ability for a consumer 804 to fund the payment transaction.

### Computer System Architecture

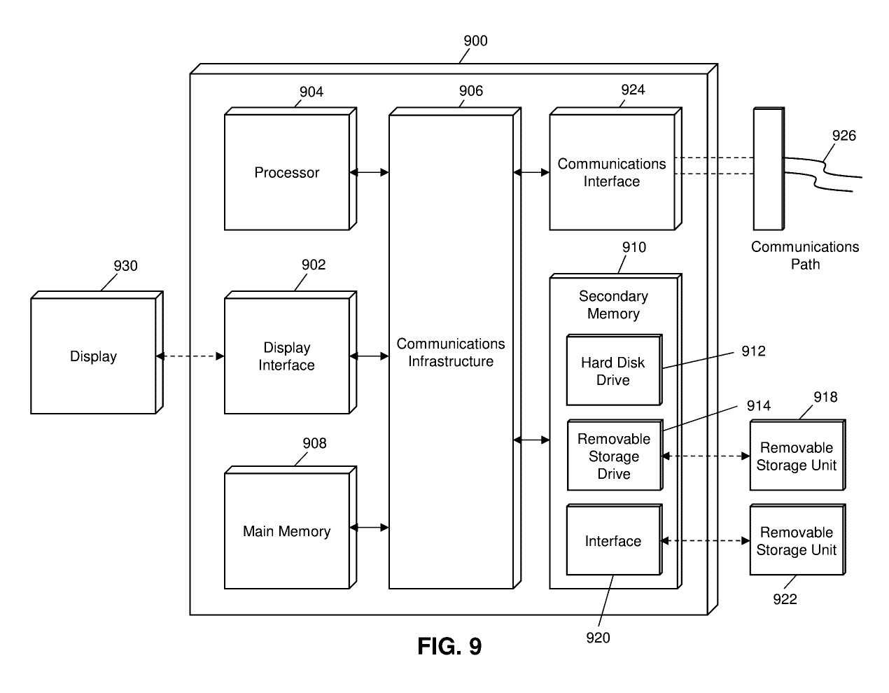

FIG. 9 illustrates a computer system 900 in which embodiments of the present disclosure, or portions thereof, may be implemented as computer-readable code. For example, the processing server 102 of FIG. 1 may be implemented in the computer system 900 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 3 and 5-8.

If programmable logic is used, such logic may execute on a commercially available processing platform or a special purpose device. A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 918, a removable storage unit 922, and a hard disk installed in hard disk drive 912.

Various embodiments of the present disclosure are described in terms of this example computer system 900. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 904 may be a special purpose or a general purpose processor device specifically configured to perform the functions discussed herein. The processor device 904 may be connected to a communications infrastructure 906, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 900 may also include a main memory 908 (e.g., random access memory, read-only memory, etc.), and may also include a secondary memory 910. The secondary memory 910 may include the hard disk drive 912 and a removable storage drive 914, such as a floppy disk drive, a magnetic tape drive, an optical disk drive, a flash memory, etc.

The removable storage drive 914 may read from and/or write to the removable storage unit 918 in a well-known manner. The removable storage unit 918 may include a removable storage media that may be read by and written to by the removable storage drive 914. For example, if the removable storage drive 914 is a floppy disk drive or universal serial bus port, the removable storage unit 918 may be a floppy disk or portable flash drive, respectively. In one embodiment, the removable storage unit 918 may be non-transitory computer readable recording media.

In some embodiments, the secondary memory 910 may include alternative means for allowing computer programs or other instructions to be loaded into the computer system 900, for example, the removable storage unit 922 and an interface 920. Examples of such means may include a program cartridge and cartridge interface (e.g., as found in video game systems), a removable memory chip (e.g., EEPROM, PROM, etc.) and associated socket, and other removable storage units 922 and interfaces 920 as will be apparent to persons having skill in the relevant art.

Data stored in the computer system 900 (e.g., in the main memory 908 and/or the secondary memory 910) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 900 may also include a communications interface 924. The communications interface 924 may be configured to allow software and data to be transferred between the computer system 900 and external devices. Exemplary communications interfaces 924 may include a modem, a network interface (e.g., an Ethernet card), a communications port, a PCMCIA slot and card, etc. Software and data transferred via the communications interface 924 may be in the form of signals, which may be electronic, electromagnetic, optical, or other signals as will be apparent to persons having skill in the relevant art. The signals may travel via a communications path 926, which may be configured to carry the signals and may be implemented using wire, cable, fiber optics, a phone line, a cellular phone link, a radio frequency link, etc.

The computer system 900 may further include a display interface 902. The display interface 902 may be configured to allow data to be transferred between the computer system 900 and external display 930. Exemplary display interfaces 902 may include high-definition multimedia interface (HDMI), digital visual interface (DVI), video graphics array (VGA), etc. The display 930 may be any suitable type of display for displaying data transmitted via the display interface 902 of the computer system 900, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 908 and secondary memory 910, which may be memory semiconductors (e.g., DRAMs, etc.). These computer program products may be means for providing software to the computer system 900. Computer programs (e.g., computer control logic) may be stored in the main memory 908 and/or the secondary memory 910. Computer programs may also be received via the communications interface 924. Such computer programs, when executed, may enable computer system 900 to implement the present methods as discussed herein. In particular, the computer programs, when executed, may enable processor device 904 to implement the methods illustrated by FIGS. 3 and 5-8, as discussed herein. Accordingly, such computer programs may represent controllers of the computer system 900. Where the present disclosure is implemented using software, the software may be stored in a computer program product and loaded into the computer system 900 using the removable storage drive 914, interface 920, and hard disk drive 912, or communications interface 924.

The processor device 904 may comprise one or more modules or engines configured to perform the functions of the computer system 900. Each of the modules or engines may be implemented using hardware and, in some instances, may also utilize software, such as corresponding to program code and/or programs stored in the main memory 908 or secondary memory 910. In such instances, program code may be compiled by the processor device 904 (e.g., by a compiling module or engine) prior to execution by the hardware of the computer system 900. For example, the program code may be source code written in a programming language that is translated into a lower level language, such as assembly language or machine code, for execution by the processor device 904 and/or any additional hardware components of the computer system 900. The process of compiling may include the use of lexical analysis, preprocessing, parsing, semantic analysis, syntax-directed translation, code generation, code optimization, and any other techniques that may be suitable for translation of program code into a lower level language suitable for controlling the computer system 900 to perform the functions disclosed herein. It will be apparent to persons having skill in the relevant art that such processes result in the computer system 900 being a specially configured computer system 900 uniquely programmed to perform the functions discussed above.

Techniques consistent with the present disclosure provide, among other features, systems and methods for identifying content for an associated group of individuals and identifying fraudulent transactions based on individual relationships. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for identifying content for an associated group of individuals, comprising:
storing, in a transaction database of a processing server, a plurality of transaction messages, wherein each transaction message is formatted based on one or more standards and includes data related to a transaction including a plurality of data elements including at least a first data element configured to store a primary account number associated with a transaction account involved in the related transaction, a second data element configured to store a merchant identifier associated with a merchant involved in the transaction, a third data element configured to store a transaction time, and one or more additional data elements configured to store transaction data;
identifying, by a transaction grouping module of the processing server, a plurality of transaction groups, wherein each transaction group includes a plurality of transaction messages where the merchant identifier stored in the second data element is a common merchant identifier and where the transaction time stored in the third data element is within a predetermined range of time;
identifying, by an account grouping module of the processing server, an account group comprising a plurality of primary account numbers, wherein each primary account number is included in at least one of the plurality transaction messages in each of two or more of the identified plurality of transaction groups;
identifying, by a transaction scoring module of the processing server, a plurality of transaction behaviors based on at least the transaction data stored in the one or more additional data elements included in each transaction message included in the two or more of the identified plurality of transaction groups where the primary account number stored in the first data element is included in the identified account group;
identifying, by a content identification module of the processing server, at least one content item based on at least the identified plurality of transaction behaviors; and
electronically transmitting, by a transmitting device of the processing server, a data signal superimposed with at least the identified at least one content item via a communication network.

2. The method of claim 1, further comprising:
storing, in an account database of the processing server, a plurality of account profiles, wherein each account profile includes data related to a transaction account including at least an account number and contact information; and
executing, by a querying module of the processing server, a query on the account database to identify, for each primary account number included in the identified account group, a related account profile where the included account number corresponds to the respective primary account number.

3. The method of claim 2, wherein the electronically transmitted data signal is further superimposed with the contact information stored in the related account profile identified for each primary account number included in the identified account group.

4. The method of claim 2, wherein the electronically transmitted data signal is transmitted to a computing device associated with each related account profile identified for each primary account number included in the identified account group based on the included contact information.

5. The method of claim 1, wherein the identified at least one content item is an offer associated with a transaction and includes at least an offer value.

6. The method of claim 5, further comprising:
receiving, by a receiving device of the processing server, a data signal superimposed with an acceptance notification indicating acceptance of the offer including at least one of the primary account numbers included in the identified transaction group; and
increasing, by a value calculation module, the offer value.

7. The method of claim 1, wherein identifying the at least one content item comprises:
electronically transmitting, by the transmitting device of the processing server, a data signal superimposed with at least the identified plurality of transaction behaviors to a content provider; and
receiving, by the receiving device of the processing server, a data signal from the content provider superimposed with the at least one content item.

8. The method of claim 1, further comprising:
storing, in a content database of the processing server, a plurality of content items, each content item being associated with one or more transaction behaviors, wherein
identifying the at least one content item includes executing, by a querying module of the processing server, a query on the content database to identify the at least one content item based on a correspondence between the associated one or more transaction behaviors and the identified plurality of transaction behaviors.

9. A method for identifying fraudulent transactions based on individual relationships, comprising:
storing, in a transaction database of a processing server, a plurality of transaction messages, wherein each transaction message is formatted based on one or more standards and includes data related to a transaction including a plurality of data elements including at least a first data element configured to store a primary account number associated with a transaction account involved in the related transaction, a second data element configured to store a merchant identifier associated with a merchant involved in the transaction, a third data element configured to store a transaction time, and one or more additional data elements configured to store transaction data;
identifying, by a transaction grouping module of the processing server, a plurality of transaction groups, wherein each transaction group includes a plurality of transaction messages where the merchant identifier stored in the second data element is a common merchant identifier and where the transaction time stored in the third data element is within a predetermined range of time;
identifying, by an account grouping module of the processing server, an account group comprising a plurality of primary account numbers, wherein each primary account number is included in at least one of the plurality transaction messages in each of two or more of the identified plurality of transaction groups;
calculating, by a transaction scoring module of the processing server, a fraud score for the identified account group based on at least a correlation between at least one of: the common merchant identifier stored in the second data element, the transaction time stored in the third data element, and transaction data stored in the one or more additional data elements included in a transaction message in each of the identified plurality of transaction groups where the primary account number stored in the first data element is included in the identified account group; and
electronically transmitting, by a transmitting device of the processing server, a data signal superimposed with at least the calculated fraud score and a respective primary account number, for each primary account number of the plurality of primary account numbers comprising the identified account group, to a financial institution associated with the respective primary account number.

10. The method of claim 9, wherein the data signal is electronically transmitted to the financial institution if the calculated fraud score is above a predetermined threshold associated with the financial institution.

11. A system for identifying content for an associated group of individuals, comprising:
a transaction database of a processing server configured to store a plurality of transaction messages, wherein each transaction message is formatted based on one or more standards and includes data related to a transaction including a plurality of data elements including at least a first data element configured to store a primary account number associated with a transaction account involved in the related transaction, a second data element configured to store a merchant identifier associated with a merchant involved in the transaction, a third data element configured to store a transaction time, and one or more additional data elements configured to store transaction data;
a transaction grouping module of the processing server configured to identify a plurality of transaction groups, wherein each transaction group includes a plurality of transaction messages where the merchant identifier stored in the second data element is a common merchant identifier and where the transaction time stored in the third data element is within a predetermined range of time;
an account grouping module of the processing server configured to identify an account group comprising a plurality of primary account numbers, wherein each primary account number is included in at least one of the plurality transaction messages in each of two or more of the identified plurality of transaction groups;
a transaction scoring module of the processing server configured to identify a plurality of transaction behaviors based on at least the transaction data stored in the one or more additional data elements included in each transaction message included in the two or more of the identified plurality of transaction groups where the primary account number stored in the first data element is included in the identified account group;
a content identification module of the processing server configured to identify at least one content item based on at least the identified plurality of transaction behaviors; and
a transmitting device of the processing server configured to electronically transmit a data signal superimposed with at least the identified at least one content item via a communication network.

12. The system of claim 11, further comprising:
an account database of the processing server configured to store a plurality of account profiles, wherein each account profile includes data related to a transaction account including at least an account number and contact information; and
a querying module of the processing server configured to execute a query on the account database to identify, for each primary account number included in the identified account group, a related account profile where the included account number corresponds to the respective primary account number.

13. The system of claim 12, wherein the electronically transmitted data signal is further superimposed with the contact information stored in the related account profile identified for each primary account number included in the identified account group.

14. The system of claim 12, wherein the electronically transmitted data signal is transmitted to a computing device associated with each related account profile identified for each primary account number included in the identified account group based on the included contact information.

15. The system of claim 11, wherein the identified at least one content item is an offer associated with a transaction and includes at least an offer value.

16. The system of claim 15, further comprising:
a receiving device of the processing server configured to receive a data signal superimposed with an acceptance notification indicating acceptance of the offer including at least one of the primary account numbers included in the identified transaction group; and
a value calculation module configured to increase the offer value.

17. The system of claim 11, wherein identifying the at least one content item comprises:
electronically transmitting, by the transmitting device of the processing server, a data signal superimposed with at least the identified plurality of transaction behaviors to a content provider; and
receiving, by the receiving device of the processing server, a data signal from the content provider superimposed with the at least one content item.

18. The system of claim 11, further comprising:
a content database of the processing server configured to store a plurality of content items, each content item being associated with one or more transaction behaviors, wherein
identifying the at least one content item includes executing, by a querying module of the processing server, a query on the content database to identify the at least one content item based on a correspondence between the associated one or more transaction behaviors and the identified plurality of transaction behaviors.

19. A system for identifying fraudulent transactions based on individual relationships, comprising:
a transaction database of a processing server configured to store a plurality of transaction messages, wherein each transaction message is formatted based on one or more standards and includes data related to a transaction including a plurality of data elements including at least a first data element configured to store a primary account number associated with a transaction account involved in the related transaction, a second data element configured to store a merchant identifier associated with a merchant involved in the transaction, a third data element configured to store a transaction time, and one or more additional data elements configured to store transaction data;
a transaction grouping module of the processing server configured to identify a plurality of transaction groups, wherein each transaction group includes a plurality of transaction messages where the merchant identifier stored in the second data element is a common merchant identifier and where the transaction time stored in the third data element is within a predetermined range of time;
an account grouping module of the processing server configured to identify an account group comprising a plurality of primary account numbers, wherein each primary account number is included in at least one of the plurality transaction messages in each of two or more of the identified plurality of transaction groups;
a transaction scoring module of the processing server configured to calculate a fraud score for the identified account group based on at least a correlation between at least one of: the common merchant identifier stored in the second data element, the transaction time stored in the third data element, and transaction data stored in the one or more additional data elements included in a transaction message in each of the identified plurality of transaction groups where the primary account number stored in the first data element is included in the identified account group; and
a transmitting device of the processing server configured to electronically transmit a data signal superimposed with at least the calculated fraud score and a respective primary account number, for each primary account number of the plurality of primary account numbers comprising the identified account group, to a financial institution associated with the respective primary account number.

20. The system of claim 19, wherein the data signal is electronically transmitted to the financial institution if the calculated fraud score is above a predetermined threshold associated with the financial institution.
